(19) United States
(12) Patent Application Publication
(10) Pub. No.: US 2019/0058206 A1
(43) Pub. Date: Feb. 21, 2019

(54) REDOX FLOW BATTERY

(71) Applicant: NISSIN ELECTRIC CO., LTD., Kyoto-shi, Kyoto (JP)

(72) Inventors: Yuki UEMURA, Kyoto-shi (JP); Hotaruko FUJIMOTO, Kyoto-shi (JP); Hiroshige DEGUCHI, Kyoto-shi (JP)

(21) Appl. No.: 16/077,893

(22) PCT Filed: Feb. 16, 2016
(86) PCT No.: PCT/JP2016/054472

§ 371 Date: Aug. 14, 2018

(51) Int. Cl. H01M 8/18; H01M 8/0245; H01M 4/66; H01M 8/0234; H01M 8/0232

(52) U.S. Cl. CPC H01M 8/188; H01M 8/0245; H01M 4/661; H01M 8/0232; H01M 4/667; H01M 8/0234; H01M 4/663

(57) ABSTRACT

A redox flow battery is provided that comprises a cell including two electrodes and a separation membrane. The two electrodes are a positive electrode and a negative electrode between which the separation membrane is arranged. At least one of the two electrodes includes an electrode member that has a non-carbon-based porous sheet and a carbon-based conductive film formed on the porous sheet. The electrode member is configured such that an electrolyte solution can flow in the thickness direction of the electrode member.

### TECHNICAL FIELD

The present invention relates to a redox flow battery.

### BACKGROUND ART

Redox flow batteries generally use strongly acidic electrolyte solutions. An electrolyte solution including a vanadium redox substance has been put to practical use as an example of strongly acidic electrolyte solution. Since metal redox ions are stably dissolved in a strongly acidic electrolyte solution even at a relatively high concentration, the energy density of a battery can be increased. However, materials constituting a redox flow battery are required to have chemical resistance to withstand a strongly acidic electrolyte solution. Meanwhile, for example, patent document 1 discloses a technique making it possible to moderate the chemical resistance required for the material constituting the redox flow battery and avoid using expensive materials by using an electrolyte solution having a pH of 2 or more.

Carbon felt is generally used for the electrode of the redox flow battery described above (see patent document 2). An electrode made of a carbon-based conductive film is also known as an electrode other than the carbon felt electrode (see patent document 3). The conductive film is formed on the current collector plate, and the current collector plate is generally made of glassy carbon or plastic carbon.

### PRIOR ART DOCUMENTS

### Patent Documents

Patent Document 1: International Publication No. WO 2015/092883
Patent Document 2: Japanese National phase Laid-Open Patent Publication No. 2014-530476
Patent Document 3: International Publication No. WO 2013/118278

### SUMMARY OF THE INVENTION

### Problems that are to be Solved by the Invention

Configuring the electrode of a redox flow battery without using the carbon felt is effective in terms of promoting the spread of redox flow batteries.

An object of the present invention is to provide a redox flow battery which makes it possible to promote the spread of redox flow batteries.

### Means for Solving the Problems

In order to attain the above object and in accordance with one aspect of the present invention, a redox flow battery is provided that comprises a cell including two electrodes and a separation membrane, wherein the two electrodes are a positive electrode and a negative electrode between which the separation membrane is arranged, characterized in that at least one of the two electrodes includes an electrode member that has a non-carbon-based porous sheet and a carbon-based conductive film formed on the porous sheet, and the electrode member is configured such that an electrolyte solution can flow in the thickness direction of the electrode member.

In the redox flow battery, it is preferable that the porous sheet be made of a metal.

In the redox flow battery, it is preferable that the electrode member have an uneven main surface.

In the redox flow battery, it is preferable that the electrode member be one of a plurality of electrode members including a first electrode member and a second electrode member, the second electrode member be arranged between the first electrode member and the separation membrane, the porous sheet of the first electrode member and the porous sheet of the second electrode member be both made of a metal, the first electrode member have an uneven main surface, and the second electrode member have a flat main surface.

In the redox flow battery, it is preferable that the conductive film of the electrode member include a carbon-based powder and a binder, and the binder be a fluororesin.

In the redox flow battery, it is preferable that the conductive film of the electrode member include a graphene powder.

In the redox flow battery, it is preferable that the graphene powder be contained in the conductive film of the electrode member in an amount of 10% by mass or more.

In the redox flow battery, it is preferable that the cell further include a current collector plate, and the current collector plate include a non-porous metal plate and a carbon-based conductive film formed on the metal plate.

In the redox flow battery, it is preferable that a positive electrode electrolyte solution and a negative electrode electrolyte solution having a pH of 1 or more and 7 or less be supplied to the cell.

### BRIEF DESCRIPTION OF THE DRAWINGS

FIG. 1 is a schematic diagram showing a redox flow battery according to an embodiment of the present invention.

FIG. 2 is a cross-sectional view showing a disassembled cell.

FIG. 3 is a cross-sectional view showing a cell.

FIG. 4 is a schematic cross-sectional view showing a cell stack.

### MODES FOR CARRYING OUT THE INVENTION

Described hereinbelow is a redox flow battery according to one embodiment of the present invention.

### <Overall Configuration of Redox Flow Battery>

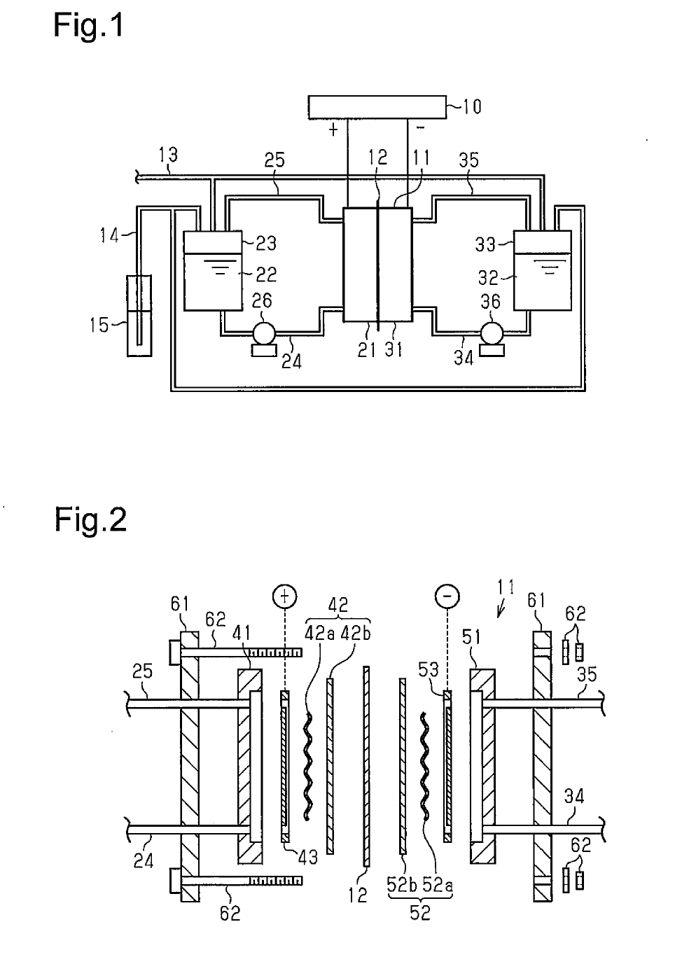

As shown in FIG. 1, the redox flow battery includes a charge/discharge cell 11. The inside of the cell 11 is partitioned into a positive electrode cell 21 and a negative electrode cell 31 by a separation membrane 12. The redox flow battery is provided with a positive electrode electrolyte solution tank 23 for storing a positive electrode electrolyte solution 22 used for the positive electrode cell 21 and a negative electrode electrolyte solution tank 33 for storing a negative electrode electrolyte solution 32 used for the negative electrode cell 31. The redox flow battery includes, as necessary, a temperature adjustment device (not shown) for adjusting the temperature around the charge/discharge cell 11.

The positive electrode electrolyte solution tank 23 is connected to the positive electrode cell 21 by a supply pipe 24 and a recovery pipe 25. The supply pipe 24 is equipped with a pump 26. By the operation of the pump 26, the positive electrode electrolyte solution 22 in the positive electrode electrolyte solution tank 23 is supplied to the positive electrode cell 21 through the supply pipe 24. At this time, the positive electrode electrolyte solution 22 in the positive electrode cell 21 is recovered into the positive electrode electrolyte solution tank 23 through the recovery pipe 25. Thus, the positive electrode electrolyte solution 22 circulates between the positive electrode electrolyte solution tank 23 and the positive electrode cell 21.

The negative electrode electrolyte solution tank 33 is connected to the negative electrode cell 31 by a supply pipe 34 and a recovery pipe 35. The supply pipe 34 is equipped with a pump 36. By the operation of the pump 36, the negative electrode electrolyte solution 32 in the negative electrode electrolyte solution tank 33 is supplied to the negative electrode cell 31 through the supply pipe 34. At this time, the negative electrode electrolyte solution 32 in the negative electrode cell 31 is recovered into the negative electrode electrolyte solution tank 33 through the recovery pipe 35. Thus, the negative electrode electrolyte solution 32 circulates between the negative electrode electrolyte solution tank 33 and the negative electrode cell 31.

An inactive gas supply pipe 13 is connected to the positive electrode electrolyte solution tank 23 and the negative electrode electrolyte solution tank 33 for supplying an inactive gas thereto. An inactive gas is supplied to the inactive gas supply pipe 13 from an inactive gas generator (not shown). By supplying an inactive gas to the positive electrode electrolyte solution tank 23 and the negative electrode electrolyte solution tank 33 through the inactive gas supply pipe 13, contact of the positive electrode electrolyte solution 22 and the negative electrode electrolyte solution 32 with oxygen in the atmosphere is suppressed. Examples of the inactive gas used include nitrogen gas. The inactive gas supplied to the positive electrode electrolyte solution tank 23 and the negative electrode electrolyte solution tank 33 is released through a release pipe 14. A water sealing portion 15 is provided at the distal end (release side end) of the release pipe 14 for water sealing the distal end opening of the release pipe 14. The water sealing portion 15 prevents the atmosphere from flowing back into the release pipe 14 and keeps a constant pressure in the positive electrode electrolyte solution tank 23 and the negative electrode electrolyte solution tank 33. The redox flow battery is electrically connected to a charge/discharge device 10.

<Configuration of Cell>

Next, the configuration of the cell 11 will be described. For convenience of explanation, the configuration of a single cell will be described herein.

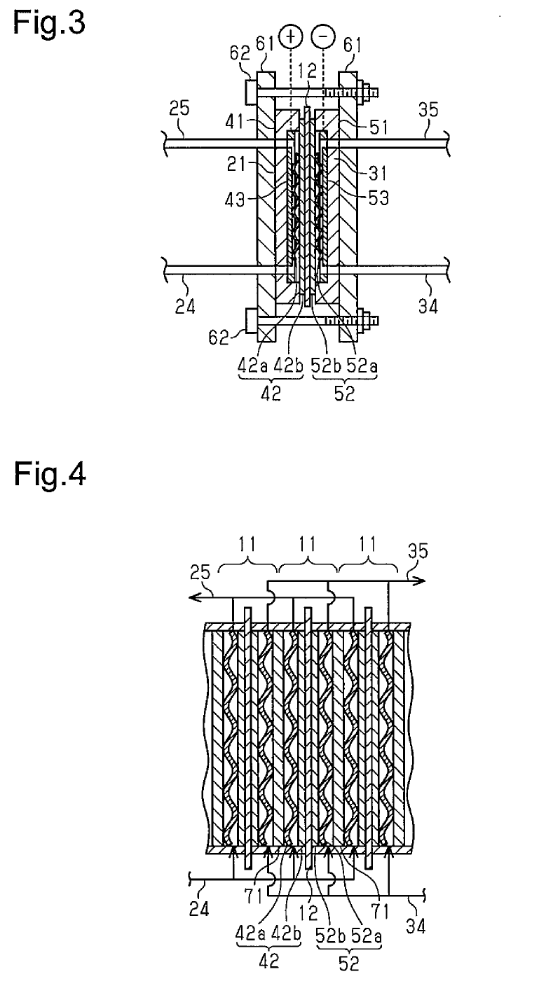

As shown in FIGS. 2 and 3, the cell 11 includes a positive electrode frame 41 and a negative electrode frame 51. In the positive electrode frame 41, a positive electrode 42 and a positive electrode current collector plate 43 are provided in this order closer to the separation membrane 12. In the negative electrode frame 51, a negative electrode 52 and a negative electrode current collector plate 53 are provided in this order closer to the separation membrane 12.

The cell 11 is sandwiched between a pair of end plates 61. The two end plates 61 are tightened to each other by a plurality of fasteners 62. Leakage of the electrolyte solution from the cell 11 is prevented by providing, as needed, a sealing member (not shown) between the two end plates 61.

The positive electrode 42 includes a first electrode member 42a and a second electrode member 42b that is provided between the first electrode member 42a and the separation membrane 12. Specifically, the first electrode member 42a faces the positive electrode current collector plate 43 and is in contact therewith. The first electrode member 42a and the second electrode member 42b face each other and are in contact with each other. The second electrode member 42b faces the separation membrane 12 and is in contact therewith.

The negative electrode 52 includes a first electrode member 52a and a second electrode member 52b that is provided between the first electrode member 52a and the separation membrane 12. Specifically, the first electrode member 52a faces the negative electrode current collector plate 53 and is in contact therewith. The first electrode member 52a and the second electrode member 52b face each other and are in contact with each other. The second electrode member 52b faces the separation membrane 12 and is in contact therewith.

The first electrode members 42a, 52a and the second electrode members 42b, 52b each have a non-carbon-based porous sheet and a carbon-based conductive film formed on the porous sheet. Each of the first electrode members 42a, 52a and the second electrode members 42b, 52b is configured so that the electrolyte solution can flow in the thickness direction. That is, the first electrode members 42a, 52a and the second electrode members 42b, 52b each have a large number of through holes that are present in the porous sheet. The first electrode members 42a, 52a each have uneven main surfaces (front and back surfaces). Although each main surface of the first electrode members 42a, 52a of the present embodiment has a wavy shape, the main surface may be dotted with protrusions or recesses. The second electrode members 42b, 52b each have flat main surfaces (front and back surfaces).

The conductive film of each of the first electrode members 42a, 52a can be provided so as to cover at least a part of the porous sheet. The conductive film of each of the second electrode members 42b, 52b can be provided so as to cover at least a part of the porous sheet. It is preferable that the entire portion of each of the first electrode members 42a, 52a and the second electrode members 42b, 52b that is in contact with the electrolyte solution be composed of a conductive film. For example, it is preferable that the inner surface defining each of the through holes of the porous sheet be composed of a conductive film.

Each of the porous sheets of the present embodiment is composed of a metal sheet. That is, the porous sheets are made of a metal. Each of the metal sheets has a large number of through holes, and specific examples thereof include an expanded metal, a punching metal, and a metal wire mesh. Examples of the metal of the metal sheets include stainless steel (for example, SUS430), aluminum (for example, aluminum 5000 series such as A5052), and titanium or a titanium alloy. The metal of the metal sheets is preferably titanium or a titanium alloy. The thickness of each of the metal sheets is preferably in the range of 10 μm or more and 100 μm or less.

When the open area ratio (aperture ratio) of each of the metal sheets is increased, it is easy to improve the contact area between the electrode member and the electrolyte solution. Reducing the open area ratio of each of the metal sheets makes it easier to increase the rigidity of the electrode member. The open area ratio of each of the metal sheets is expressed as a percentage of the area of holes per unit area (for example, 1 m²) of the metal sheet in a plan view of the metal sheet. A metal sheet having an open area ratio of, for example, 27.0% or 43.5% can be used for constituting each of the first electrode members 42a, 52a. A metal sheet having an open area ratio of, for example, 72.8% can be used for constituting each of the second electrode members 42b, 52b.

The positive electrode current collector plate 43 has a non-porous metal plate and a carbon-based conductive film that is formed on the metal plate and is in contact with the positive electrode electrolyte solution 22. The negative electrode current collector plate 53 has a non-porous metal plate and a carbon-based conductive film that is formed on the metal plate and is in contact with the negative electrode electrolyte solution 32. Examples of the metal of the metal plates of the positive electrode current collector plate 43 and the negative electrode current collector plate 53 include stainless steel (for example, SUS 430), aluminum (for example, aluminum 5000 series such as A5052), and titanium or a titanium alloy. The metal of the metal sheets is preferably titanium or a titanium alloy.

The conductive film of the positive electrode current collector plate 43 can be provided so as to cover at least a part of the metal plate. The conductive film of the negative electrode current collector plate 53 can be provided so as to cover at least a part of the metal plate. It is preferable that the entire portion of each of the positive electrode current collector plate 43 and the negative electrode current collector plate 53 that is in contact with the electrolyte solution be composed of a conductive film.

The conductive film of each of the first electrode members 42a, 52a, the second electrode members 42b, 52b, the positive electrode current collector plate 43, and the negative electrode current collector plate 53 includes a carbon-based powder and a binder. Examples of the carbon-based powder include a graphite powder, a graphene powder, and an acetylene black powder. One or more types of the carbon-based powder may be used.

It is preferable that each of the conductive films include a graphene powder as the carbon-based powder. The particle shape of the graphene powder is, for example, a flaky shape, the thickness of the graphene layer is, for example, 10 nm or less, and the particle diameter (the outer diameter of the flat surface of the flake) is, for example, in the range of 100 nm or more and 50 μm or less. The content of the graphene powder in each of the conductive films is preferably 10% by mass or more. The content of the graphene powder in each of the conductive films is preferably 90% by mass or less.

The graphite powder may be a natural graphite powder or an artificial graphite powder. The particle size of the graphite powder is preferably in the range of 1 μm or more and 100 μm or less, more preferably in the range of 3 μm or more and 50 μm or less. The content of the graphite powder in each of the conductive films is preferably, for example, in the range of 5% by mass or more and 90% by mass or less.

The particle size of the acetylene black powder is preferably in the range of 1 nm or more and 100 nm or less, more preferably in the range of 30 nm or more and 50 nm or less. The content of the acetylene black powder in each of the conductive films is preferably, for example, in the range of 1% by mass or more and 20% by mass or less.

The total content of the carbon-based powder in each of the conductive films is preferably in the range of 70% by mass or more and 97% by mass or less.

A synthetic resin material can be used as the binder. The binder is preferably a fluororesin. Examples of the fluororesin include polytetrafluoroethylene, polyvinylidene fluoride, and polyvinyl fluoride. The content of the binder in each of the conductive films is preferably in the range of 3% by mass or more and 10% by mass or less.

An additive such as a thickening agent may be contained in each of the conductive films.

The thickness of each of the conductive films is preferably in the range of 1 μm or more and 500 μm or less.

In order to form a conductive film, firstly, a conductive slurry including the above-mentioned materials and a dispersion medium or a solvent is prepared, and the conductive slurry is coated on the metal sheet or metal plate. As the dispersion medium or solvent, for example, N-methylpyrrolidone is used. The conductive slurry is obtained by kneading the above-mentioned materials with a well-known kneader. A method of coating the conductive slurry is not particularly limited, and for example, a known coater may be used, or a dipping method may be used.

Next, a conductive film is formed by drying the coated conductive slurry. Drying of the conductive slurry can be carried out at a normal temperature or under heating. Drying of the conductive slurry can be carried out under atmospheric pressure or under reduced pressure.

<Operation of Redox Flow Battery>

When the redox flow battery is charged, the oxidation reaction is performed in the positive electrode electrolyte solution 22 that is in contact with the positive electrode 42, and the reduction reaction is performed in the negative electrode electrolyte solution 32 that is in contact with the negative electrode 52. That is, the positive electrode 42 emits electrons and the negative electrode 52 receives electrons. At this time, the positive electrode current collector plate 43 supplies the charge/discharge device 10 with the electrons emitted from the positive electrode 42. The negative electrode current collector plate 53 supplies the negative electrode 52 with the electrons received from the charge/discharge device 10.

When the redox flow battery is discharged, the reduction reaction is performed in the positive electrode electrolyte solution 22 that is in contact with the positive electrode 42, and the oxidation reaction is performed in the negative electrode electrolyte solution 32 that is in contact with the negative electrode 52. That is, the positive electrode 42 receives electrons and the negative electrode 52 emits electrons. At this time, the positive electrode current collector plate 43 supplies the positive electrode 42 with the electrons received from the charge/discharge device 10.

<Electrolyte Solution>

The pH of the positive electrode electrolyte solution 22 and the pH of the negative electrode electrolyte solution 32 are preferably in the range of 1 or more and 7 or less. When the pH of the positive electrode electrolyte solution 22 and the pH of the negative electrode electrolyte solution 32 are 1 or more, the chemical resistance required for the material constituting the redox flow battery is more easily moderated. When the pH of the positive electrode electrolyte solution 22 and the pH of the negative electrode electrolyte solution 32 are 7 or less, for example, the solubility of the active material is easily ensured. The pH is a value measured, for example, at 20° C.

Examples of the active material in the electrolyte solutions include an iron redox substance, a titanium redox substance, a chromium redox substance, a manganese redox substance, and a copper redox substance. The “redox substance” as referred to in the present application means a metal ion, a metal complex ion, or a metal generated by the redox reaction of a metal.

In order to suppress precipitation within the abovementioned pH range, the active material is preferably contained in each of the electrolyte solutions as a metal complex. A chelating agent for forming the metal complex is one capable of forming a complex with the active material, and examples thereof include amines, citric acid, lactic acid, aminocarbon chelating agents, and polyethyleneimine.

Details of an example of the positive electrode electrolyte solution 22 and the negative electrode electrolyte solution 32 will be described below.

The positive electrode electrolyte solution 22 includes an iron redox substance and an acid. The acid is citric acid or lactic acid.

In the positive electrode electrolyte solution 22, iron functions as an active material. For example, at the time of charging, oxidation from iron (II) to iron (III) is supposed to occur, and at the time of discharging, reduction from iron (III) to iron (II) is supposed to occur. Since the positive electrode electrolyte solution 22 includes the above-mentioned acid, a practical electromotive force can be easily obtained.

From the viewpoint of increasing the energy density, the concentration of the iron redox substance (iron ion) in the positive electrode electrolyte solution 22 is preferably 0.2 mol/L or more, more preferably 0.3 mol/L or more, and more preferably 0.4 mol/L or more. The concentration of the iron redox substance (iron ion) in the positive electrode electrolyte solution 22 is preferably 1.0 mol/L or less.

The molar ratio of the acid to the iron redox substance in the positive electrode electrolyte solution 22 is preferably in the range of 1 or more and 4 or less. When the molar ratio is 1 or more, the electric resistance of the positive electrode electrolyte solution 22 becomes lower, so that it is easy to increase the Coulomb efficiency and the utilization factor of the positive electrode electrolyte solution 22. When the molar ratio is 4 or less, both high cost efficiency and high practicality can be achieved.

If necessary, the positive electrode electrolyte solution 22 can include, for example, a salt of an inorganic acid or various chelating agents.

The negative electrode electrolyte solution 32 is an electrolyte solution including a titanium redox substance and an acid. The acid is citric acid or lactic acid.

In the negative electrode electrolyte solution 32, titanium functions as an active material. For example, at the time of charging, reduction from titanium (IV) to titanium (III) is supposed to occur, and at the time of discharging, oxidation from titanium (III) to titanium (IV) is supposed to occur. As a result of including the above-mentioned acid, the negative electrode electrolyte solution 32 is complexed and the potential is lowered by about 0.2 V, so that a practical electromotive force can be easily obtained.

From the viewpoint of increasing the energy density, the concentration of the titanium redox substance (titanium ion) in the negative electrode electrolyte solution 32 is preferably 0.2 mol/L or more, more preferably 0.3 mol/L or more, and more preferably 0.4 mol/L or more. The concentration of the titanium redox substance (titanium ion) in the negative electrode electrolyte solution 32 is preferably 1.0 mol/L or less.

The molar ratio of the acid to the titanium redox substance in the negative electrode electrolyte solution 32 is preferably in the range of 1 or more and 4 or less. When the molar ratio is 1 or more, the electric resistance of the negative electrode electrolyte solution 32 becomes lower, so that it is easy to increase the Coulomb efficiency and the utilization factor of the negative electrode electrolyte solution 32. When the molar ratio is 4 or less, both high cost efficiency and high practicality can be achieved.

If necessary, the negative electrode electrolyte solution 32 can include, for example, a salt of an inorganic acid or various chelating agents.

The positive electrode electrolyte solution 22 and the negative electrode electrolyte solution 32 can be prepared by a known method. The water used for the positive electrode electrolyte solution 22 and the negative electrode electrolyte solution 32 preferably has a purity equal to or higher than that of distilled water.

According to the present embodiment described above, the following operations and effects are obtained.

(1) In the redox flow battery of the present embodiment, each of the electrodes includes, for example, a first electrode member 42a, 52a as an electrode member having a non-carbon based porous sheet and a carbon-based conductive film that is formed on the porous sheet. Each of the first electrode members 42a, 52a is configured such that the positive electrode electrolyte solution 22 can flow in the thickness direction thereof.

With such a configuration, it is possible to reduce the cost of the electrode member as compared with the case of using carbon felt as the electrode member. Therefore, it becomes possible to promote the spread of redox flow batteries. Further, it is possible to ensure a wider contact area between the electrode member and the electrolyte solution by using the liquid permeability of the non-carbon-based porous sheet, so that favorable battery characteristics are easily exhibited.

(2) The porous sheet of each of the electrode members is a metal sheet. As a result, the electric conductivity of the electrode member can be enhanced, and durability of the electrode member can be easily obtained.

(3) Since the first electrode members 42a, 52a have uneven main surfaces, the flow of the electrolyte solution in contact with the first electrode members 42a, 52a easily becomes turbulent. As a result, the reaction of the electrolyte solution is easily promoted, so that favorable battery characteristics are easily obtained.

(4) The positive electrode 42 includes a first electrode member 42a and a second electrode member 42b that is provided between the first electrode member 42a and the separation membrane 12. Each of the porous sheets of the first electrode member 42a and the second electrode member 42b is a metal sheet. The first electrode member 42a has an uneven main surface. The second electrode member 42b has a flat main surface. With such a configuration, the operation and effect described in section (3) hereinabove can be obtained by the first electrode member 42a. Furthermore, since the separation membrane 12 can be supported by the second electrode member 42b, the separation membrane 12 can be suitably protected. In the present embodiment, the operation and effect is exhibited also for the first electrode member 52a and the second electrode member 52b of the negative electrode 52.

(5) Each of the conductive films preferably includes a carbon-based powder and a binder, and the binder is preferably a fluororesin. In this case, since the fluororesin of the binder has water resistance, the metal sheet constituting each of the electrode members can be suitably protected by this water resistance. Accordingly, since the durability of the electrode members can be enhanced, the lifetime of the cell 11 of the redox flow battery can be prolonged.

(6) Each of the conductive films preferably includes a graphene powder. Here, the graphene powder is considered to have more active points of a redox reaction than a graphite powder. As a result, it is easy to promote the redox reaction of the electrolyte solution. Therefore, suitable battery characteristics are easily obtained.

(7) The content of the graphene powder in each of the conductive films is preferably 10% by mass or more. In this case, the redox reaction of the electrolyte solution can be further promoted. Therefore, suitable battery characteristics are easily obtained.

(8) The cell 11 further includes, for example, a positive electrode current collector plate 43 as the current collector plate. The positive electrode current collector plate 43 has a non-porous metal plate and a carbon-based conductive film that is formed on the metal plate.

With such a configuration, since it is possible to configure the current collector plate at a lower cost than when using, for example, glassy carbon or plastic carbon as the current collector plate, it becomes possible to promote the spread of redox flow batteries. In addition, since it is possible to promote the reaction of the electrolyte solution on the carbon-based conductive film of the current collector plate, suitable battery characteristics are easily obtained.

(9) The pH of the positive electrode electrolyte solution 22 and the pH of the negative electrode electrolyte solution 32 are preferably in the range of 1 or more and 7 or less. In this case, since the chemical resistance required for the material constituting the redox flow battery is moderated, it becomes possible to promote the spread of redox flow batteries.

(Modifications)

The above-described embodiment may be modified as follows.

In the positive electrode 42, either one of the first electrode member 42a and the second electrode member 42b may be omitted. Further, in the negative electrode 52, either one of the first electrode member 52a and the second electrode member 52b may be omitted. For example, the second electrode member 42b may be changed to, for example, a polypropylene mesh.

The electrode member of either the positive electrode 42 or the negative electrode 52 may be configured of, for example, only carbon felt. In addition, the configuration of at least one of the positive electrode 42 and the negative electrode 52 may be changed so that, for example, carbon felt is provided as a third electrode member. In this case, it is also possible to reduce the amount of carbon felt used, and it is possible to reduce the cost of the electrode members.

A large number of through holes of the porous sheet of each of the electrode members may be formed, for example, by etching a nonporous metal sheet.

The porous sheet of each of the electrode members is not limited to a metal sheet and may be a woven fabric or a nonwoven fabric composed of fibers other than carbon fibers. Examples of the fibers other than carbon fibers include synthetic fibers (for example, polyamide fibers), semisynthetic fibers (for example, acetate), regenerated fibers (for example, cellulose fibers), and inorganic fibers (for example, glass fibers). For example, depending on the material constituting each of the porous sheets, the binder of the conductive film formed on the porous sheet may be changed to a synthetic resin other than the fluororesin. Examples of the synthetic resin other than fluororesin include an acrylic resin.

As shown in FIG. 4, the redox flow battery may include a cell stack composed of a plurality of cells 11. In the cell stack, the positive electrode current collector plate 43 and the negative electrode current collector plate 53 can be changed to a bipolar plate 71 as a current collector plate provided so as to partition between two adjacent cells 11. That is, the bipolar plate 71 has a non-porous metal plate and carbon-based conductive films formed on both surfaces of the metal plate.

At least one of the positive electrode current collector plate 43 and the negative electrode current collector plate 53 may be configured of glassy carbon or plastic carbon.

At least one of the positive electrode current collector plate 43 and the negative electrode current collector plate 53 may be omitted.

The capacity of the positive electrode electrolyte solution tank 23 and the capacity of the negative electrode electrolyte solution tank 33 of the redox flow battery can be changed according to, for example, the performance required for the redox flow battery. The supply amounts of the positive electrode electrolyte solution 22 and the negative electrode electrolyte solution 32 to the charge/discharge cell 11 can be set in accordance with, for example, the capacity of the charge/discharge cell 11.

### EXAMPLES

Next, the present invention will be described in greater detail by examples.

### <Production of Electrode Member (A)>

A first electrode member and a second electrode member were prepared as the electrode member (A) in the following manner.

A conductive film was formed by coating the following conductive slurry on a metal sheet (expand metal, made of pure titanium) as a non-carbon-based porous sheet.

Carbon-based powder: graphite powder (KS6L, manufactured by TIMCAL Ltd.), 0.52 g

Carbon-based powder: graphene powder (trade name: xGnP-C-300, manufactured by XG Sciences, Inc.), 4.70 g

Carbon-based powder (conductive aid): acetylene black powder (trade name: Denka Black, manufactured by Denki Kagaku Kogyo Kabushiki Kaisha), 0.42 g

Binder: polyvinylidene fluoride solution (KF Polymer #9305, manufactured by Kureha Corporation), 7.20 g (solid content 0.36 g)

Dispersion medium: N-methylpyrrolidone, 12.75 g

The conductive slurry was prepared by kneading the above-mentioned materials with a planetary ball mill.

A conductive adhesive (trade name: HITASOL GA-703, manufactured by Hitachi Powdered Metals Co., Ltd.) was coated on the expanded metal in advance and dried for 12 hours at 80° C. under normal pressure. Next, the conductive slurry was coated on the expanded metal, dried for 12 hours at 80° C. under normal pressure, and then dried under vacuum for 30 hours at 200° C. The expanded metal having the conductive film formed thereon was pressed with a load of 300 kN to fill the pores in the conductive film.

Next, the first electrode member was obtained by press-molding so that the main surface of the expanded metal on which the conductive film was formed was uneven (depth of protrusions and recesses is 1.4 mm and the pitch is 5 mm).

The second electrode member was produced in the same manner as the first electrode member except that the press-molding for preparing the uneven main surface of the expanded metal on which the conductive film was formed was omitted.

### <Production of Electrode Member (B)>

As a non-carbon-based porous sheet, a conductive film was formed by coating the following conductive slurry on a fiber material (hemp towel).

Carbon-based powder: graphite powder (KS6L, manufactured by TIMCAL Ltd.), 1.0 g

Carbon-based powder: graphene powder (xGnP-C-300, manufactured by XG Sciences, Inc.), 8.96 g

Conductive aid: acetylene black powder (trade name: Denka Black, manufactured by Denki Kagaku Kogyo Kabushiki Kaisha), 0.37 g

Binder: acrylic resin (AZ-9001, manufactured by Zeon Corporation), 1.01 g (solid content: 0.36 g)

Thickening agent: cellulosic thickener (DN-10L, DN-800H, manufactured by Daicel Chemical Industries, Ltd.)

Dispersion medium: distilled water, 40 g First, the conductive slurry was prepared by kneading the carbon-based powder and the thickening agent with a planetary ball mill to obtain a mixture, then adding the binder, the conductive aid, and the dispersion medium to the mixture, and further kneading with the planetary ball mill.

The obtained conductive slurry was coated on the fiber material by spraying and dried under the condition of normal pressure for 12 hours. The fiber material having the conductive film formed thereon in this manner was washed in distilled water and then dried under the condition of normal pressure for 12 hours. By this washing, clogging of the fiber material by the conductive film was reduced, and liquid permeability of the electrode member (B) was improved.

<Preparation of Current Collector Plate>

Current collector plates were each prepared by forming a conductive film on a non-porous metal plate (made of pure titanium). The conductive films were formed in the same manner as the conductive film of the first electrode member.

<Conductivity Evaluation>

A load of 150 g was applied from above the laminate in which the first electrode member of the electrode member (A) was sandwiched between a pair of upper and lower copper plates, and the electric resistance between the pair of copper plates was measured with a tester. For the electrode member (B), the electric resistance was measured in the same manner as for the first electrode member of the electrode member (A). The electric resistance of the first electrode member of the electrode member (A) was 4.4Ω), the electric resistance of the electrode member (B) was 49.6Ω), and the electrode member (A) was higher in electric conductivity than the electrode member (B).

<Redox Flow Battery>

For each of the positive electrode and the negative electrode, the first electrode member and the second electrode member of the electrode member (A) were used. The abovementioned current collector plates were used as the positive electrode current collector plate and the negative electrode current collector plate. A commercially available cation exchange membrane (CMS, manufactured by ASTOM Corporation) was used as the separation membrane. Glass containers each having a capacity of 30 mL were used as the positive electrode electrolyte solution tank and the negative electrode electrolyte solution tank. Silicone tubes were used as the supply pipe, the recovery pipe, the inactive gas supply pipe, and the release pipe. A microtube pump (MP-1000, manufactured by Tokyo Rikakikai Co., Ltd.) was used as the pump. A charge/discharge battery test system (PFX 200, manufactured by Kikusui Electronics Corporation) was used as the charge/discharge device.

<Preparation of Iron (II)-Citric Acid Complex Aqueous Solution>

A total of 0.04 mol (8.4 g) of citric acid was dissolved in 30 mL of distilled water. To this aqueous solution, 1.2 g (corresponding to 0.02 mol of ammonia) of 28% by mass aqueous ammonia was added. Next, 0.02 mol (4.0 g) of FeCl.4H₂O was dissolved in this aqueous solution. Next, distilled water was added to this aqueous solution so that the total amount was 100 mL. As a result, an aqueous solution having an iron (II)-citric acid complex concentration of 0.2 mol/L and a pH of 2.5 was obtained.

<Preparation of Titanium (IV)-Citric Acid Complex Aqueous Solution>

A total of 0.06 mol (12.6 g) of citric acid was dissolved in 50 mL of distilled water. To this aqueous solution, 6.1 g (corresponding to 0.10 mol of ammonia) of 28% by mass aqueous ammonia was added and then 0.093 mol of NaOH was added. Next, 16.0 g (corresponding to 0.02 mol of titanium (IV)) of 30% by mass Ti(SO₄)₂ solution was added to this aqueous solution. Next, distilled water was added to this aqueous solution so that the total volume was 100 mL. As a result, an aqueous solution having a titanium (IV)-citric acid complex concentration of 0.2 mol/L and a pH of 4.49 was obtained.

<Charge/Discharge Test>

A charge/discharge test was carried out using the iron (II)-citric acid complex aqueous solution as the positive electrode electrolyte solution and the titanium (IV)-citric acid complex aqueous solution as the negative electrode electrolyte solution. The charge/discharge test was started with charging, and initially charging was performed at a constant current of 50 mA for 108 minutes (a total of 324 coulombs). Next, discharging was performed at a constant current of 50 mA to the discharge end voltage of 0 V for 96 minutes (total 288 coulombs) (first cycle). The charging time for the second and subsequent cycles was 96 minutes (total 288 coulombs).

The redox reaction during charging and discharging is estimated in the following manner.

iron (II)-citric acid complex↔iron (III)-citric acid complex+e⁻. Positive electrode:

titanium (IV)-citric acid complex+e⁻↔titanium (III)-citric acid complex Negative electrode:

In the charge/discharge test, the Coulomb efficiency at the fourth cycle and the energy efficiency at the time of charging and discharging over 4 cycles were determined.

The Coulomb efficiency is calculated by substituting, into the following Equation (1), the Coulomb amount (A) in charging and the Coulomb amount (B) in discharging at the fourth cycle.

Coulomb efficiency [%]=B/A×100 (1)

The energy efficiency is calculated by substituting, into the following Equation (2), the amount of electricity (C) in charging and the amount of electricity (D) in discharging (D) at the four cycles of charging and discharging.

Energy efficiency [%]=D/C×100 (2)

In this charge/discharge test, the Coulomb efficiency of the redox flow battery was 98% and the energy efficiency was 83%.

1. A redox flow battery comprising a cell that includes two electrodes and a separation membrane, wherein the two electrodes are a positive electrode and a negative electrode between which the separation membrane is arranged, wherein
at least one of the two electrodes includes an electrode member that has a non-carbon-based porous sheet and a carbon-based conductive film formed on the porous sheet, and
the electrode member is configured such that an electrolyte solution can flow in a thickness direction of the electrode member.

2. The redox flow battery according to claim 1, wherein the porous sheet is made of a metal.

3. The redox flow battery according to claim 2, wherein the electrode member has an uneven main surface.

4. The redox flow battery according to claim 1, wherein
the electrode member is one of a plurality of electrode members including a first electrode member and a second electrode member,
the second electrode member is arranged between the first electrode member and the separation membrane,
the porous sheet of the first electrode member and the porous sheet of the second electrode member are both made of a metal, and
the first electrode member has an uneven main surface, and the second electrode member has a flat main surface.

5. The redox flow battery according to claim 2, wherein
the conductive film of the electrode member includes a carbon-based powder and a binder, and
the binder is a fluororesin.

6. The redox flow battery according to claim 1, wherein the conductive film of the electrode member includes a graphene powder.

7. The redox flow battery according to claim 6, wherein the graphene powder is contained in the conductive film of the electrode member in an amount of 10% by mass or more.

8. The redox flow battery according to claim 1, wherein
the cell further includes a current collector plate, and
the current collector plate includes a non-porous metal plate and a carbon-based conductive film formed on the metal plate.

9. The redox flow battery according to claim 1, wherein a positive electrode electrolyte solution and a negative electrode electrolyte solution that have a pH of 1 or more and 7 or less are supplied to the cell.
